(19) United States
(12) Patent Application Publication
(10) Pub. No.: US 2002/0136440 A1
(43) Pub. Date: Sep. 26, 2002

(54) Vessel surface reconstruction with a tubular deformable model

(76) Inventors: Peter J. Yim, Bethesda, MD (US); Peter L. Choyke, Bethesda, MD (US); Mullick Rakesh, Bangalore (IN)

Correspondence Address: FITCH EVEN TABIN AND FLANNERY, 120 SOUTH LA SALLE STREET, SUITE 1600, CHICAGO, IL, 60603-3406, US

(21) Appl. No.: 09/934,968

(22) Filed: Aug. 22, 2001

Related U.S. Application Data
(60) Provisional application No. 60/229,017, filed on Aug. 30, 2000.
(60) Provisional application No. 60/269,159, filed on Feb. 15, 2001.

(51) Int. Cl. G06K 9/00

(52) U.S. Cl. 382/131

(57) ABSTRACT

An apparatus, article of manufacture, and method for modeling an elongated object located internal to a body (e.g., blood vessels such as the carotid artery or the renal artery). Magnetic resonance data of the area of concern is collected. The magnetic resonance data is analyzed, extracting gradient information. The extracted gradient information may include the gradient of the magnitude gradient. Contemporaneously, a tubular coordinate system is interactively generated as an initial model of the artery. An axis and a reference circumferential direction are defined for the coordinate system with radial lines extending outward from the axis. Intersecting radial lines are merged. All vertices at radial and circumferential positions are initialized with the extracted gradient information. Then, the initialized model is deformed subjecting initialized vertices to image and smoothing forces, thereby completing the surface model of the artery, effectively reconstructing the artery surface. The reconstructed artery surface may be displayed on a display.

### RELATED APPLICATIONS

This application is based on, and claims benefit of, U.S. Provisional Application Serial No. 60/229,017 filed on Aug. 30, 2000, and U.S. Provisional Application Serial No. 60/269,159 filed on Feb. 15, 2001.

### BACKGROUND OF THE INVENTION

1. Technical Field of the Invention

This invention generally relates to a data analysis method, apparatus and article of manufacture and more particularly to apparatus, article of manufacture and analysis method for analyzing arterial stenosis.

2. Description of Related Art

Atherosclerosis is assessed according to the degree of stenosis of diseased vessels. For example, stenosis of the carotid artery of greater than 70% represents a high risk of stroke and should be corrected by endarterectomy. The standard method for measuring the degree of stenosis is digital subtraction angiography (DSA) which provides high-contrast projection images of vessels from multiple viewpoints. However, DSA requires intra-arterial placement of a catheter that can have serious medical complications. Thus, alternatives to DSA have been proposed including magnetic resonance angiography (MRA), 3D ultrasound, and computed tomographic angiography (CTA). These methods are attractive because they are all less invasive than DSA and provide 3D images of the vessel lumen. However, the images from these methods are significantly more difficult to interpret due to lower image resolution and contrast.

A variety of methods have been applied to the problem of vessel-surface reconstruction from 3D angiography. The simplest method for reconstruction of vessel surfaces is iso-surface reconstruction. In this method, the location of the surface is determined strictly according to image intensity. A smooth surface is produced by placing the vertices at fractional image grid locations such that the interpolated image intensity is constant on the surface. However, choice of the threshold or iso-intensity level may be problematic, particularly for MRA, due to image inhomogeneities and other artifacts. Thus, the use of the iso-intensity surface is restricted to qualitative applications.

Surface reconstruction of vessels has also been obtained from segmentation methods. Segmentation methods incorporate spatial and intensity criteria to objectively classify regions or voxels in an image. For example, a k-means clustering method automatically identifies voxels within vessels from MRA. This method compensates for the partial volume effect that diminishes the intensity of the smaller vessels thus causing errors for methods based on image intensity alone. Another method uses “fuzzy connectivity” for separating arteries and veins in MRA obtained with blood pool contrast agents. The arteries and veins are separated from the arteries based on a limited number of seed points inside and outside of the vessels. A similar watershed method has been successfully applied to MRA of the thoracic aorta.

Once the image has been segmented, surfaces can be readily composed from segmentation boundaries although considerable smoothing must be applied and topological errors must be corrected. However, these segmentation methods incorporate only very limited a priori knowledge of the anatomy. Thus, while the shapes created by these methods directly reflect the information in the images, they tend to suffer unnecessarily from errors due to image artifacts or image noise. Several model-based approaches have been taken to address this problem.

Several multi-scale methods have been applied to the problem of vessel surface reconstruction. In these methods, the width of objects in grey-scale images are automatically determined for any given point in the image by matching the objects with convolution kernels of various sizes. Thus, for points along a vessel, an average vessel diameter is obtained. Together with the vessel axis, the diameter measurements fully describe the vessel surface. However, all such multi-scale methods for vessel surface reconstruction assume that the vessel has a symmetric cross-sectional shape. Therefore, these methods have limited application for reconstruction of the vessel shape near bifurcations or in the presence of vascular disease such as atherorsclerosis.

Another class of methods, the deformable models, allows for more general vessel shapes while still providing the useful smoothing effects. In the deformable models, surfaces deform according to image and smoothing “forces.” The image forces pull the surface toward edges in the image while the smoothing forces resist bending of the surface and maintain even spacing of vertices of the surface mesh. Several deformable models have been applied to reconstruction of vessel surfaces. Two dimensional (2D) methods have been proposed in which the vessel boundary is reconstructed independently for each slice or plane. These provide adequate results for the cases tested but improvements can certainly be obtained by unified three dimensional (3D) reconstruction methods.

Several general-purpose 3D deformable models have shown promise for surface reconstruction of large vessels. These methods have the potential to reconstruct non-tubular shapes such as vessel aneurisms and to provide an integrated reconstruction of bifurcations from minimal initializations. However, gross errors from these surface reconstructions have been found to occur in the region of bifurcations.

Frangi et al. in “Model-based Quantization of 3-D Magnetic Angiographic Images” IEEE T Med. Imaging, vol. 18, pp. 946-56 (1999), describe a 3D deformable model developed specifically for vessel surface reconstruction. The Frangi et al. model is based on a cylindrically parameterized surface mesh. Since the cylindrical mesh is well-suited for vessel shape, a greater degree of smoothing can be obtained than from more generalized deformable model meshes. The model is initialized by a multi-scale method in which the axis is constructed while simultaneously estimating vessel diameter. Once the deformable model is initialized, the mesh deforms according to the conventional mechanical analogy. However, there are inherent limitations in this deformable model. One limitation is that the smoothing constraints used in this model inherently bias the surface reconstruction. For example, the “stretching” force on the surface vertices, which is meant to produce an even spacing of vertices, also tends to constrict the vessel. While a “bending” force is imposed to counteract that constriction effect, a complete cancellation cannot be obtained. Another inherent problem of this deformable model is the limited maximum density of vertices in the surface mesh. While this model can be readily initialized for a low density of vertices, surface self-intersection problems will occur if the density of vertices is increased in the axial direction. These shortcomings limit the accuracy of any vessel model, which may cause underestimation of vessel stenosis or, in the extreme, to completely overlooking the existence thereof. Further, measurement of vessel stenosis from 3D angiographic methods can be problematic due to limited image resolution and contrast.

Thus, there is a need for improved, more accurate ways to display and analyze possibly diseased arteries.

### SUMMARY OF THE INVENTION

It is a purpose of the present invention to improve reconstruction of vessel shape from 3D angiography;

It is another purpose of the present invention to facilitate an objective evaluation of vessel shape;

It is yet another purpose of the present invention to improve the precision of shape measurements from 3D angiography;

It is yet another purpose of the present invention to allow for more sophisticated characterization of vessel shape at stenoses;

It is yet another purpose of the present invention to improve vessel surface reconstruction thereby facilitating accurate computational fluid dynamics (CFD) modeling of arterial blood flow;

It is yet another purpose of the present invention to accurately estimate of fluid-mechanical conditions in a vessel that may be a factor in the progression of atherosclerosis.

The present invention is an apparatus, article of manufacture, and method for modeling an elongated object located internal to a body. The elongated object may be a blood vessel such as the carotid artery or the renal artery. Magnetic resonance imaging data of the area of concern (e.g., the carotid artery) is collected. The magnetic resonance imaging data is analyzed, extracting gradient information. The gradient information may include the gradient of the magnitude gradient. Contemporaneously, a tubular coordinate system is interactively generated as an initial model of the artery. An axis and a reference circumferential direction are defined for the coordinate system with radial lines extending outward from the axis. Intersecting lines are merged. All vertices at radial and circumferential positions are initialized with the extracted gradient information. Then, the initialized model is deformed, subjecting initialized vertices to image and smoothing forces, thereby completing the surface model of the artery, effectively reconstructing the artery surface. The reconstructed artery surface may be displayed on a display.

Thus, the tubular deformable model of the present invention is advantageous for quantification of vessel shape from 3D angiograph, particularly, where there is a mild rate of tapering of the lumen at a stenosis. In such subtle situations, the tubular deformable model of the present invention is likely to provide a more accurate measurement of the degree of stenosis than from manual interpretation. The preferred embodiment deformable model provides enable more accurate realistic CFD modeling of blood flow patterns and better assessment of the risk of stroke, for example, posed by a given abnormality in the carotid lumen shape.

In addition, the tubular deformable model of the present invention provides enhanced artery-vein separation in contrast-enhanced MRA, allowing application of the method of the present invention to a vein nearby to an artery of interest. Once the surface of the vein is reconstructed, it is nulled-out to leave an unobstructed view of the artery.

The method is a deformable model that employs a tubular coordinate system. Vertex merging is incorporated into the coordinate system to maintain even vertex spacing and to avoid problems of self-intersection of the surface.

### BRIEF DESCRIPTION OF DRAWINGS

The present invention will become more fully understood from the detailed description given hereinbelow and the accompanying drawings which are given by way of illustration only, and thus are not limitative of the present invention, and wherein:

FIG. 1 shows a schematic representation of a magnetic resonance analysis system for reconstructively modeling blood vessel surfaces with a tubular deformable model according to the preferred embodiment of the present invention.

FIG. 2 shows the reference circumferential orientation for a curved axis;

FIG. 3 shows an example of smoothing force deformation of surface mesh vertices about axis (a) analogous to mechanical deformation.

FIG. 4 shows an example of how points may be identified along the axis of the vessel.

FIG. 5 shows the reference circumferential orientation as defined for a curved axis tubular coordinate system.

FIG. 6 shows a tubular coordinate system wherein the radial lines are warped in areas where the vessel axis is curved.

FIG. 7 shows meshes constructed from vertices at constant radial locations for a curved axis, i.e., on isodistance surfaces.

FIG. 8 shows surface reconstruction of phantom of carotid bifurcation reconstructed from an MR image of a glass phantom. A single slice of the image is shown in Panel A. Panels B and C show the surface reconstruction of overlapping segments. Panel D shows the bifurcation region by superimpostion of the two surfaces of B and C.

FIG. 9 is a example of surface reconstruction of carotid artery bifurcation from a normal subject. Panel A provides a cropped portion of the MRA in the sagital view. The segments are reconstructed separately (Panels B and C) and displayed as a superimposed image (Panel D) with shaped surfaces.

FIG. 10 shows surface reconstruction of performed on a carotid artery from a subject with stenosis of the carotid artery. Panel A provides a contrast-enhanced MRA. The segments are reconstructed separately in Panels B (external carotid artery) and C (internal carotid artery); the surface of the internal segment was manually indented at the grove between the internal and external carotid arteries (arrow in Panel C) where an error otherwise occurs due to discontinuity of the tubular shapes at that point. Panel D provides the superimposed image with shaped surfaces.

FIG. 11 shows surface reconstruction applied to MRA of patient with renal artery stenosis using the tubular deformable model. Panel A provides MRA. Reconstruction was performed independently on the aorta (Panel B) and the left renal artery (Panel C). The vessels are superimposed and visulaized as shaded surfaces in Panel D.

### DETAILED DESCRIPTION OF PREFERRED EMBODIMENTS

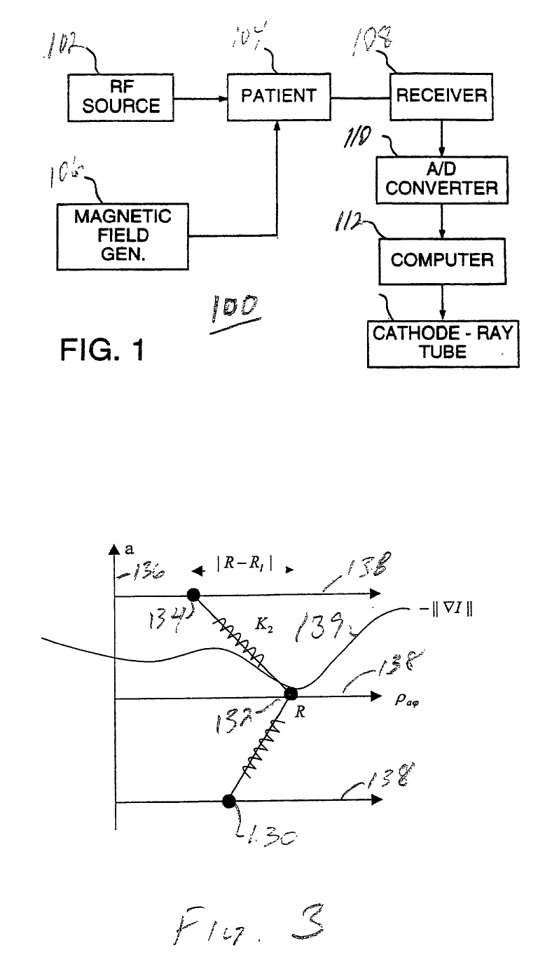

Turning now to the drawings and, more particularly, FIG. 1 shows a schematic representation of a magnetic resonance analysis system 100 for reconstructively modeling blood vessel surfaces with a tubular deformable model according to the preferred embodiment of the present invention. It should be noted that, although the preferred embodiment is described herein with application to magnetic resonance imaging, it may be applied to reconstruction of images derived from other signal sources, e.g., acoustic data or acoustic resonance data, without departing from the spirit or scope of the invention. Thus, for example, the method of the present invention may be applied to ultrasound imaging.

So, continuing, a pulsed radio frequency (RF) energy source 102 is directed to a patient 104 disposed in a main magnetic field generated by magnetic field generator 106. Receiver 108 receives magnetic energy emissions in response to the pulsed RF. Resonant magnetic energy signals received by the receiver 108 are passed to a analog-to-digital (A/D) converter 110. Magnetic resonance digital data from the AID converter 110 is passed to computer 112. Computer 112, converts the magnetic resonance digital data to viewable image data which is displayed on a suitable display screen, such as a cathode-ray tube 114, for example.

Thus, according to the preferred embodiment of the present invention, image data collected from a patient 104 on the above system 100 is modeled, with allowances for curves in the vessel axis, variability in the vessel diameter and variability in cross-sectional shape. In the preferred deformable model, vessel shape is described by a radial function of axial and circumferential position, R(a, Φ), Z²→R within a tubular coordinate system. The tubular coordinate system, described in detail hereinbelow, resembles the cylindrical coordinate system but accommodates curved axes. The tubular coordinate system applied to a straight axis is identical to the well known cylindrical coordinate system.

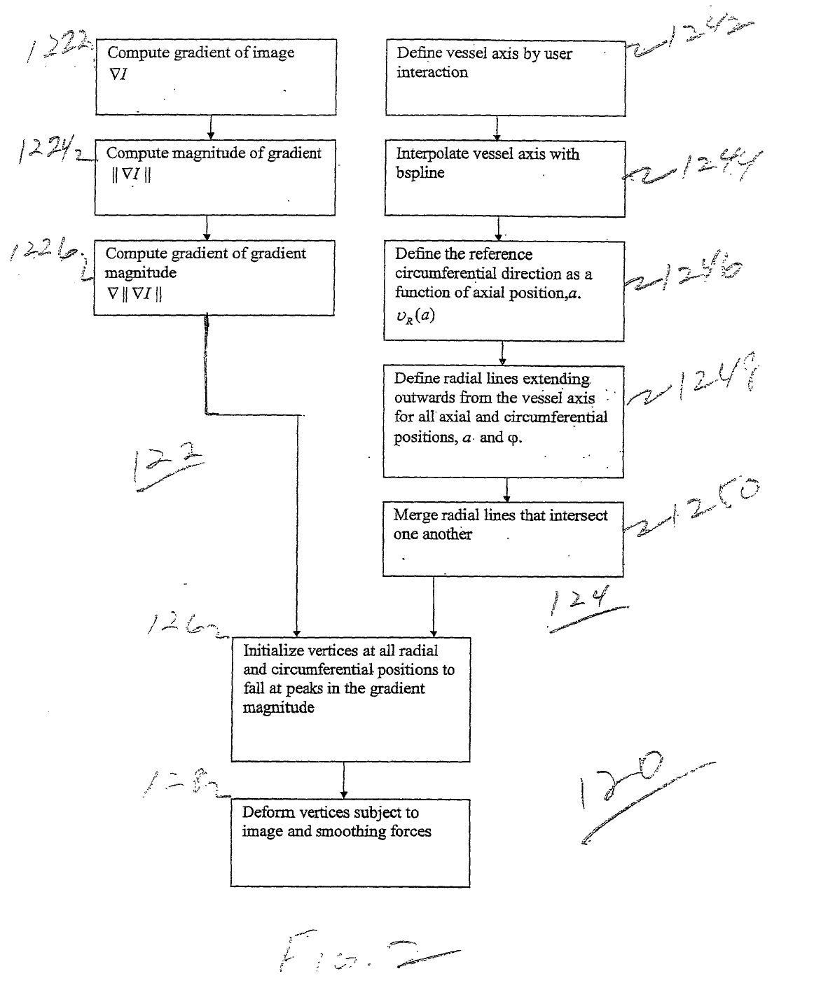

FIG. 2 shows an example of a flow diagram of the preferred embodiment method 120 for reconstructing vessel surfaces using a tubular deformable model. The preferred method 120 is bifurcated wherein gradient information is extracted in one leg 122 and, coincidentally, a tubular definition of the vessel is determined in the other leg 124. In step 126 the tubular information is combined with the gradient information, initializing the tubular vertices at all radial and circumferential positions. In step 128, the initialized tubular model is deformed, using additional gradient information, to result in the desired surface reconstruction.

Thus, gradient information extraction begins in step 1222 as the image gradient is computed. Next, in step 1224 the magnitude of the gradient is computed. This gradient magnitude is provided to step 126 for initialization for the tubular model developed in step 124, such that all vertices fall at peaks in the gradient magnitude. Then, in step 1226 the gradient of the gradient magnitude is computed. This gradient of the gradient magnitude provides images and smoothing forces that are applied to the initialized shape in step 128, deforming the shape to complete reconstruction.

Tubular shape definition begins in step 1242 wherein a user interactively defines the vessel being reconstructed. Preferably, this definition is done by taking slices through the vessel and the user identifying the vessel axis within the slice. Next, in step 1244 the vessel axis is interpolated using a b-spline method to connect the identified points. In step 1246 the reference circumferential direction is defined. The reference circumferential direction is a function of axial position, a. Next, in step 1248, radial lines are defined for all axial and circumferential positions, a and Φ, respectively. The radial lines extend outwards from the vessel axis. Tubular shape definition is completed in step 1250, when intersecting radial lines are merged.

Accordingly, a discrete surface is described by a set of vertices that are evenly spaced in the axial and circumferential directions. Variation in vertex position only occurs, however, in the radial direction. The radial lines are described as paths r_{aΦ}, constructed as provided hereinbelow. For a tubular coordinate system with a straight axis, the radial paths are straight lines projecting radially outwards from the axis.

So, in step 1222, ∇I is obtained by convolution of the image with the gradient of the normalized spherical gaussian function (space constant, σ=1 voxel unit). The radial function R(a, Φ) is the value of the radial parameter rₒ at the maxima of the gradient magnitude. Next in step 1224, the magnitude of the gradient is computed such that:

∥∇I(ρ_{aΦ}(r₀))∥≧∥∇I(ρ_{aΦ}(r))∥∀rε(0,rₗᵢₘᵢₜ) (1)

where rₗᵢₘᵢₜ is the value of the radial parameter at the furthest extent of the radial line. A further provision is that a decrease in image intensity occurs at that point proceeding outwards from the vessel center:

∇I(ρ_{aΦ}(r₀))·v_{aΦ}(r₀)>0 (2)

where v_{aΦ}is a unit vector in the direction of the radial line:

$${v}_{a ϕ} ( r ) ≡ \frac{{ρ}_{a ϕ}^{′} ( r )}{‖ {ρ}_{a ϕ}^{′} ( r ) ‖} . \qquad ( 3 )$$

The radial function deforms so as to minimize discontinuities in the radial position along the surface while maximizing the proximity of the vertices to edges in the image. The result is an equilibration process analogous to that of a mechanical system acted on by internal elastic forces and external forces.

In step 1226, the gradient of the previously computed gradient magnitude is found for use in determining the instantaneous deformation of vertices. The instantaneous deformation of a vertex at any axial-circumferential location is given by:

$$Δ r = {K}_{1} ( {K}_{2} {\sum }_{neighbor} ( {R}_{neighbor} - R ) + {v}_{a ϕ} ( R ) \cdot ∇ ‖ ∇ I ( {ρ}_{a ϕ} ( R ) ) ‖ ) \qquad ( 4 )$$

where R_{neighbor} is the radial location of the neighbors of a given vertex within the surface mesh. The deformations are applied simultaneously to all vertices in step 126 and repeated until an equilibrium condition is obtained in step 128. An example of suitable source code for carrying out the present method is attached as an Appendix to U.S. Provisional Application Serial No. 60/269,159 (filed Feb. 15, 2001); this source code, which is hereby incorporated by reference, is designed to run as part of IRIS Explorer platform on a Silicon Graphics Unix workstation.

FIG. 3 shows an example of smoothing force deformation of surface mesh vertices 130, 132, 134 about axis (a) 136, analogous to mechanical deformation. All surface vertices 130, 132, 134 deform along radial lines, r_{aΦ}, 130. The negative gradient magnitude image provides a gravitational force (curved line 139) analog on the vertex 132, while the neighboring vertices pull the vertex with spring-like forces. The spring-like smoothing forces are proportional to the difference in the radial locations between the vertices 130, 132, 134.

Additional smoothing forces may be included in the deformation process. For example, forces may be applied through user interaction to correct for gross errors in the surface reconstruction. An “anchor” manually placed at location (aₘₐₙᵤₐₗ, Φₘₐₙᵤₐₗ,rₘₐₙᵤₐₗ) will attract the surface towards itself. The modified deformation is given by:

$$Δ {r}_{manual} = Δ r + δ ( {a}_{manual} , {ϕ}_{manual} ) {K}_{3} ( R - {r}_{manual} ) \\ \begin{matrix}where δ ( {a}_{manual} , {ϕ}_{manual} ) = 1 for ( a , ϕ ) = ( {a}_{manual} , {ϕ}_{manual} ) \\ = 0 for ( a , ϕ ) \neq ( {a}_{manual} , {ϕ}_{manual} ) .\end{matrix} \qquad ( 5 )$$

As noted hereinabove, the preferred embodiment deformable model of the vessels is based on a tubular coordinate system that allows for curvature of the cylindrical axis. The tubular coordinate system differs from the cylindrical coordinate system in several ways. Accordingly, the tubular coordinate system is constructed from a vessel axis. The axis is formed from a sequence of points along the center of the vessel identified by the user in step 1242. A sufficient number of points must be chosen to represent all the curves in the vessel. Points along the center of the vessel can be easily identified by the user by displaying slices of the image normal to the axis of the vessel side-by-side with a 3D surface display of the vessels to provide anatomical reference.

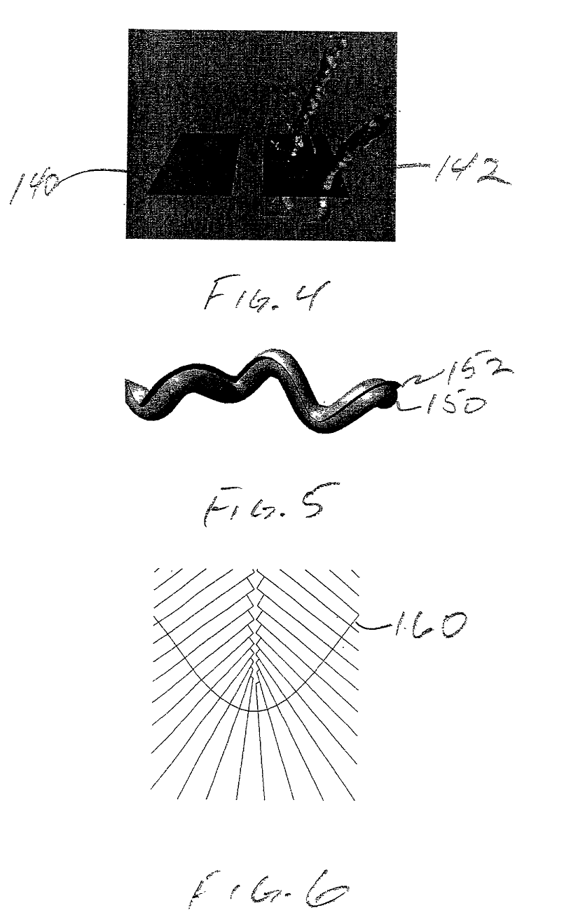

FIG. 4 shows an example of how points may be identified along the axis of the vessel 1242. A cropped portion of the carotid MRA is shown by itself 140 and with a 3D isosurface 142 to provide anatomical context that helps to follow a given vessel from one axial slice to another. In certain cases where the vessel follows a torturous path, points along the axis may be chosen from the maximum intensity projection (MIP). Identification of points on a MIP provides a 3D coordinate since each point in the MIP is associated with a single point in the 3D image in the projection process. In step 1244, the axis is smoothed with a cubic b-spline and interpolated to have a spacing of 0.5 mm between points.

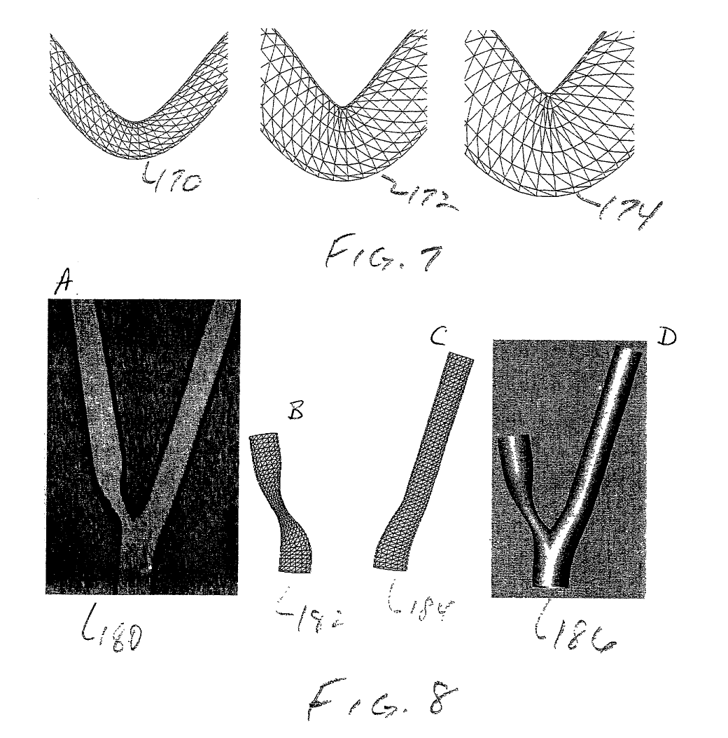

FIG. 5 shows the reference circumferential orientation as defined in step 1244 for a curved axis tubular coordinate system 150, as represented by raised ridge 152. The reference angle on which the circumferential angle is based is dependent on the curvature of the vessel axis. The circumferential orientation cannot be defined with respect to an absolute orientation due to the curvature of the axis. Rather, the circumferential component of the tubular coordinate system must be defined relative to the local curvature of the axis. A circumferential coordinate is defined such that a minimum of angular change occurs between adjacent points on the axis. Taking A(a) as the path of the vessel axis, μ(a) as the unit vector along the vessel axis at the a^{th} point, and v₀(a) as the reference radial orientation at the a^{th} axial point:

$$μ ( a ) ≡ \frac{{A}^{′} ( a )}{‖ {A}^{′} ( a ) ‖} \qquad ( 6 )$$

v_{R}(a)≡vₐ₀(0). (7)

The reference orientation at the adjacent point is then:

$${v}_{R} ( a + 1 ) = \frac{{v}_{R} ( a ) - μ ( a + 1 ) ( ( {v}_{R} ( a ) \cdot μ ( a + 1 ) )}{‖ {v}_{R} ( a ) - μ ( a + 1 ) ( ( {v}_{R} ( a ) \cdot μ ( a + 1 ) ) ‖} . \qquad ( 8 )$$

A normal radial vector is obtained by the cross product of the reference radial vector with the axis vector:

v_{N}(a)≡v_{R}(a)×μ(a). (9)

All initial radial vectors are constructed from a linear combination of the reference and normal radial directions. Sixteen (16) circumferential directions of each axial location are used, evenly circumferentially spaced about the axis. Thus:

v(a, 4,0)=v_{N}(a). (10)

A second feature of the preferred tubular coordinate system is that the radii do not emanate in straight lines from the axis at all points. As can be seen from the tubular coordinate system in the example of FIG. 6, the radial lines are warped in areas where the vessel axis 160 is curved. Radial lines from an axis 160 will intersect at the inside of axis curves, i.e., in area 162. This problem is solved in step 1250 by merging radial lines in the tubular coordinate system. Radial lines are shown for the in-plane radial directions along a curved portion of the axis of a tubular coordinate system. The radial coordinate at each point in the tubular coordinate system is the distance to the nearest point on the axis. This warping prevents radial lines from adjacent axial locations from intersecting one another.

The radial lines are defined prior to the deformation process, i.e., in step 1248. The radial lines extend outwards at a constant step size (Step_size) of 0.1 of the in-plane pixel resolution:

ρaΦ(r)=A(a)+v(a,Φ,0)×r×Step_size (11)

and in step 1250, radial lines are concatenated when intersections would occur. In principle, the radial lines from an axis will not intersect one another exactly due to the discrete locations of the radial lines and to out-of-plane components of the radial direction vectors. Thus, practical definitions of line intersections must be adopted. The radial lines are considered to intersect one another in one of two ways:

(1) A radial line intersects with an oblique or anti-parallel radial line if it reaches a point where it is closer to the origin of the second radial line than it is to its own origin. The intersection point of the radial line is designated, r_{trunc}

∥ρ_{aΦ}(r)−A(a)∥<∥ρ_{aΦ}(r)−A(a′)∥

∀r<r_{trunc} and |a−a′|>1 (12)

(2) A radial line intersects with a nearly parallel line when it is at its closest approach to the second line. The point of intersection on the second line is designated rᵢₙₜ

D =ρ_{aΦ}(r_{trunc})−ρ_{a′Φ}(rᵢₙₜ)∥

where:

∥ρ_{aΦ}(r_{trunc})−ρ_{a′Φ}(rᵢₙₜ)∥<∥ρ_{aΦ}(r)−ρ_{a′Φ}(r′)∥∀(r,r′) and |a−a′|=1. (13)

The second condition applies specifically to the intersection between two radial lines from adjacent points on the axis while the first condition applies to all other intersections. These criteria are only applied to radial lines at the same circumferential positions. The truncation of any given radial line is the minimum of r_{trunc} obtained from equations 12 and 13.

The radial lines are then modified by merging so that they extend outwards to the maximal radial position.

For r=rₗᵢₘᵢₜ−1 to r=1

For all (a,Φ)

if r_{trunc}(a,Φ)=r

r_{trunc}(a,Φ)=rₗᵢₘᵢₜ

for r′=r to rₗᵢₘᵢₜ

ρ_{aΦ}(r′)=ρₐ_{ₙₑₐᵣₑₛₜ}_{Φ}(r′)

v_{aΦ}(r′)=vₐ_{ₙₑₐᵣₑₛₜ}_{Φ}(r′)

aₙₑₐᵣₑₛₜ is the axial location of the non-concatenated radial line that is nearest in the axial direction such that:

r_{trunc}(aₙₑₐᵣₑₛₜ, Φ)=r_{limit.} (14)

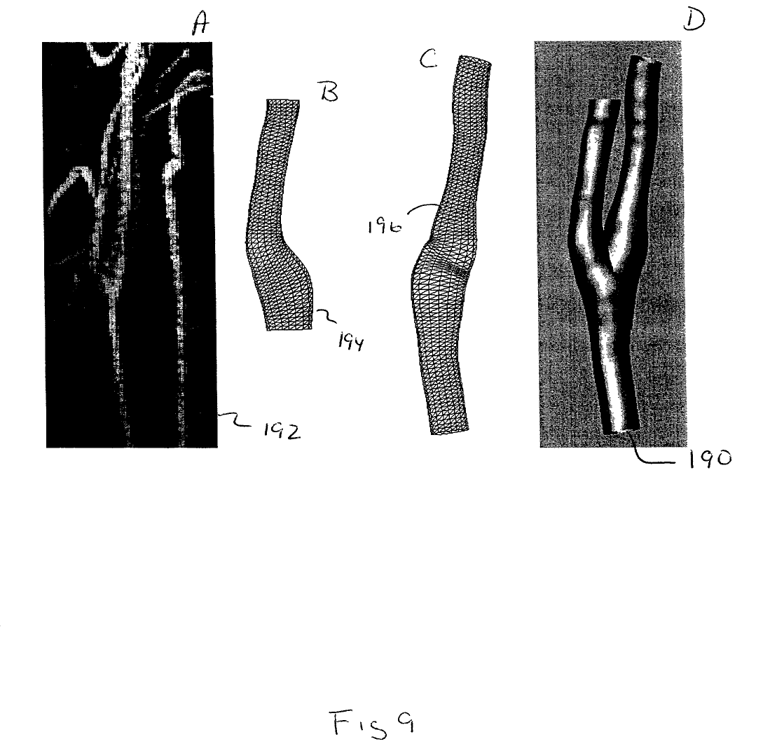

FIG. 7 shows meshes 170, 172, 174 constructed from vertices at constant radial locations for a curved axis, i.e., on isodistance surfaces. Surfaces are constructed whose vertices are at equal distances from the given axis. The meshing is done according to the tubular coordinate system. For small radii mesh 170, vertices exist for each circumferential and axial position. At larger radii meshes 172, 174, the vertices merge with one another in the axial direction to eliminate crisscrossing of radial lines.

The cylindrical deformation process could be applied directly to the modified cylindrical coordinate system. However, bunching of vertices will occur where radial lines merge. Where such bunching occurs, the effective elasticity of the surface becomes significantly greater which reduces the surface smoothness. This effect is removed by merging vertices in the deformation process to match the merging of the radial lines in step 1248. This precludes two vertices from co-existing on the same radial line. The procedure for merging vertices is as follows. The vertices initially exist for all circumferential and axial locations. After a primary deformation phase, vertices are merged with their axial neighbors if either of the vertices is at a point where the radial lines of the two vertices are merged:

Merge (a, Φ) and (a_{adjacent}, Φ) if ρ_{aΦ}(R)=ρₐ_{_{ddjacentΦ}}(R).

The radial location of the resulting vertex becomes the average of the locations of the vertices from which it was formed.

$$R ( {a}_{merged} , ϕ ) = \frac{{{\sum }^{N}}_{n} R ( {a}_{n} , ϕ )}{N} \qquad ( 15 )$$

where N vertices are merged.

Henceforth this vertex deforms as a single vertex. The neighbors of this resultant vertex are those of the merged vertices. However, the circumferential neighbors for the resultant vertex will accumulate relative to the axial neighbors. Therefore, to maintain a balance between the axial and circumferential component of the elastic force, the total circumferential elastic force must be rescaled. With regard to the equation of motion 4 the elastic component R−R_{neighbor}, the difference of radial location between a vertex and its neighbors, must be modified so that the circumferential and axial radial differences are added separately. So,

$$R - {R}_{neighbor} = {{\sum }^{2}}_{j} ( R - {R}_{j} ) + \frac{2}{N} {{\sum }_{k}}^{K} ( R - {R}_{k} ) \qquad ( 16 )$$

where K is the number of circumferential neighbors of a merged vertex.

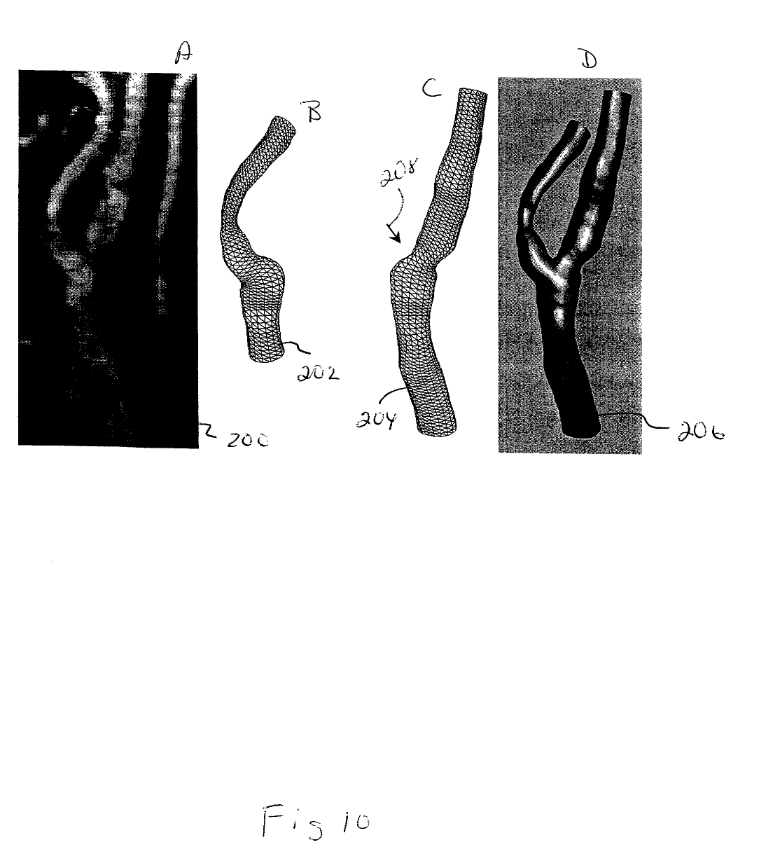

FIG. 8 shows surface reconstruction of phantom 180 of carotid bifurcation. The carotid artery bifurcation is reconstructed from an MR image of a glass phantom. A single slice 180 of the image is shown (Panel A). The surface was reconstructed with the tubular deformable model of overlapping segments 182, 184 (Panels B and C). The superimposition of the two surfaces accurately represents the bifurcation region 186 (Panel D). The tubular deformable model was applied to an MR image of a glass phantom of the carotid artery bifurcation with stenosis of the internal carotid artery (CA) (3D Spoiled Gradient Recalled Echo (SPGR), Voxel dimensions 0.31×0.31×1.0 mm, Phantom filled with 60:40 ratio water to glycerine, No fluid flow). The glass phantom was constructed according to typical dimensions (common CA (CCA)=8 mm, internal CA (ICA)=7 mm, external CA (ECA)=6 mm) with a moderate stenosis at the origin of the ICA. The CCA/ICA segment and CCA/ECA segments of the phantom were independently reconstructed from the MR image. The same value of the elasticity parameter, K₂=7×10³ cm⁻¹ is used for both the phantom and data from human subjects. The space constant of the gradient magnitude operator, ∇I(a, Φ, r), is 1.0 in-plane voxel units for all tests of the algorithm. Image contrast is similar for all images. The contrast is in the range of 200-300 gray-scale units. The reconstruction of the phantom is carried out in a total of one hundred deformation iterations. Fifty iterations are carried out prior to merging of vertices and fifty after merging of vertices. The iteration step size, K₁ was 0.05 cm.

An average vessel radii was obtained at each axial position along the vessel segments. To calculate the average radius, a cross-sectional area was calculated from the vertex positions at that radial position:

$${P}_{j} = {\sum }_{i} {T}_{i} \qquad ( 17 )$$

where Tᵢ is the triangular area between the axial point and two circumferentially adjacent points and Pⱼ is the polygonal area at the j^{th} axial location. The average radius is then given by the formula for the area of a circle multiplied by a constant factor to compensate for the difference in area between a triangle and a corresponding arc of a circle

$${radius}_{j} = \sqrt{\frac{1.025 {P}_{j}}{π}} . \qquad ( 18 )$$

The average radii of a segment was calculated from 8-10 axial points. The average radii of all segments differed from the known radii by less than 20% of the average voxel dimension. Radii at the stenosis were compared with radii measured manually from computed tomography image (CT) of the phantom (15 cm FOV, reconstructed to 0.3 mm in-plane resolution, oriented normal to axis of stenosis). The difference between the radii measured by the deformable model and from CT was 0.2 mm.

FIG. 9 is an example of surface reconstruction of carotid artery 190 bifurcation from a normal subject. A cropped portion of the MRA is visualized as a MIP in the sagital view 192 (Panel A). The CCA/ECA segment 194 (Panel B) and the CCA/ICA segment 196 (Panel C) are reconstructed separately and superimposed as a shaded surface display 198 (Panel D). Surface reconstruction of the carotid artery 190 was carried out on contrast-enhanced MRA images. MR images were acquired with contrast injection of Gd-DTPA (fast-gradient recalled echo sequence, GE Corp.) of one carotid artery from each of 4 normal subjects. As with reconstruction of the phantom 180, the reconstruction was carried out with fifty deformations prior to merging of vertices and fifty after merging. The iteration step size was also the same as for the phantom reconstruction (i.e., K₁=0.05 cm).

As with the example of FIG. 9, realistic surfaces were obtained for all 4 images that were consistent with both the MIP'sand the source images. Only a limited portion of ECA and its sub-tree was reconstructed since the vessel rapidly bifurcates which increases the complexity of identifying the axis. However, the portion of the ECA reconstructed is adequate for CFD modeling of flow in the carotid bifurcation.

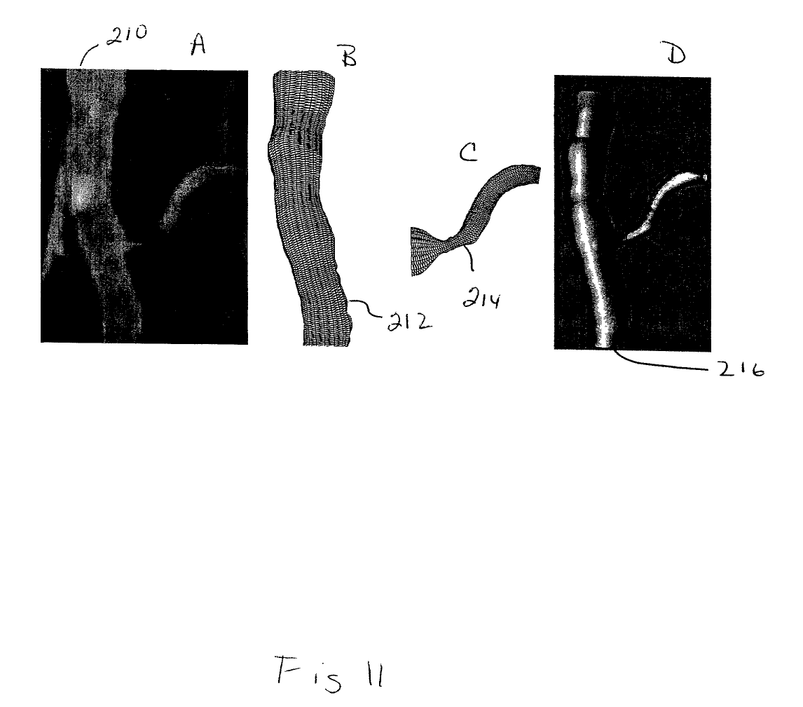

Reconstruction was performed on each of two carotid arteries from each of two subjects with stenosis of the carotid artery of which, FIG. 10 shows surface reconstruction of one, reconstructed with the tubular deformable model according to the preferred embodiment of the present invention. A carotid artery bifurcation from contrast-enhanced MRA, shown in MIP 200 (Panel A), is reconstructed as one segment continued onto the ECA 202 (Panel B) and one onto the ICA 204 (Panel C). The two surfaces are superimposed in 206 (Panel D). The surface of the internal segment was manually indented at the groove between the internal and external carotid arteries (arrow 208 in Panel C) where an error otherwise occurs due to the discontinuity of the tubular shape at that point. In another example (not shown), the reconstructed surface was found to be smooth and entirely consistent with the MIP and source images. For the image shown in FIG. 10, the surface reconstruction has one noticeable error at the origin of the ICA. At this location, an indentation in the lumen was smoothed-over in the reconstruction. This error occurred due to small size of the indentation and due to proximity to the insertion of the ECA where there is a discontinuity in the radial location of the surface. Such an error can be manually corrected by inserting a point to provide an attractive force towards the correct location as described hereinabove. The elastic coefficient of the manual attractive force K₃ was 7×10⁴ cm⁻¹ (in equation 4). When a manual attractive force is present the iteration step size was reduced to K₁=0.025 cm to avoid instability in the simulation of the mechanical deformation. The total number of deformation iterations is then increased to a total of one hundred.

The degree of stenosis apparent in the surface reconstruction is less than in the MIP. However, the discrepancy is not due purely to smoothing effects of the deformable model since a similar degree of stenosis is observed when the surface is constructed with no smoothing. The error may be attributed to the tendency of the MIP to over-estimate the degree of stenosis. Only one artery from each subject was reconstructed since, in the above example of FIG. 10, the contra-lateral vessel was occluded in one case and suffered from severe image artifacts in the other.

FIG. 11 shows surface reconstruction applied to an MRA 210 (Panel A) of patient with renal artery stenosis using the tubular deformable model 110 according to the preferred embodiment of the present invention. Reconstruction was performed independently on aorta 212 (Panel B) and on left renal artery 214 (Panel C). These vessel reconstructions are superimposed and visualized as shaded surface 216 (Panel D). For this example, the abdominal aorta and renal artery were reconstructed in two subjects with renal artery stenosis from contrast-enhanced MRA (fast gradient recalled echo sequence, GE Corp.). The surface reconstruction parameters were the same as those used for the carotid arteries. Surfaces of both the renal arteries and the aortas are smooth and are consistent with MIP and source images.

Thus, the tubular deformable model of the present invention provides a more attractive method than other state of the art methods for blood-vessel surface reconstruction from 3D angiography. While the Frangi et al. model for vessel surface reconstruction, for example, also employs a cylindrical surface mesh, the Frangi et al. model is quite different from the model of the present invention in important respects. One important advantage of the method of the present invention is found in initialization of the deformable model in step 126. The multi-scale method used by Frangi et al. (and also described by Aylward et al. in “Intensity Ridge and Widths for Tubular Object Segmentation and Description,” Proceedings of IEEE Workshop, Mathematical Methods in Biomedical Image Analysis, June, 1996) requires a consistent cross-sectional image intensity profile along blood vessels. However, for a contrast-enhanced MRA, flow and timing artifacts can significantly distort the cross-sectional image intensity profile. For example, the jugular vein, which is immediately adjacent to the carotid artery will enhance to varying degrees, depending on the rates of venous return in the given individual and to the exact timing of the image acquisition. The presence of the jugular vein next to carotid artery affects the localization of the axis of an object using Frangi et al. methods. By contrast, initialization of the tubular deformable model is a one dimensional (1D) edge detection method which assumes only that the image intensity decrease is greatest at the boundary of the lumen.

Another advantage of the method of the present invention is that meshes are constructed with high vertex density. This allows for representation of smaller-scale detail of the lumen shape such as focal stensoses or protrusions into or out from the lumen. High vertex density cannot be obtained for simple cylindrical meshes where vertices are simply placed along normals from the axis as in Frangi et al. For such a cylindrical mesh, the radial lines from nearby points along the axis will converge at the inside of curves of the cylindrical axis and intersect with one another. Advantageously, this problem is avoided in the tubular coordinate system of the present invention by a systematic merging of radial lines.

Further, the preferred tubular coordinate system allows for the description of the vessel shape in terms of a single radial parametric function. This has a subtle advantage over the rectilinear parametric functions used in the model of Frangi et al. wherein smoothing of rectilinear parametric shape functions must be biased towards either under- or over-estimation of vessel diameter. By contrast, no such bias is present in the tubular deformable model of the present invention. While the rectilinear parametric shape functions of Frangi et al. allow for reconstruction of more generalized shapes, only a modest advantage is realized for the reconstruction of blood vessel surfaces.

Thus, the tubular deformable model of the present invention is advantageous for quantification of vessel shape from 3D angiograph, particularly, where there is a mild rate of tapering of the lumen at a stenosis. In such subtle situations, the tubular deformable model of the present invention is likely to provide a more accurate measurement of the degree of stenosis than from manual interpretation. The preferred embodiment deformable model provides more accurate realistic CFD modeling of blood flow patterns and better assessment of the risk of stroke, for example, posed by a given abnormality in the carotid lumen shape. Once the vessel surface has been reconstructed, more sophisticated characterization maybe used to characterize vessel shape at stenosis. So, for example, the degree of stenosis may be easily derived by comparing the typical diameter of the vessel with the diameter at the stenosis and, in response automatically suggesting a course of treatment, e.g., surgery and/or medication.

In addition, the tubular deformable model of the present invention provides enhanced artery-vein separation in contrast-enhanced MRA, allowing application of the method of the present invention to a vein nearby to an artery of interest. Once the surface of the vein is reconstructed, it is nulled-out to leave an unobstructed view of the artery.

The method is a deformable model that employs a tubular coordinate system. Vertex merging is incorporated into the coordinate system to maintain even vertex spacing and to avoid problems of self-intersection of the surface. The deformable model was evaluated on clinical magnetic resonance (MR) images of the carotid (n=6) and renal (n=2) arteries and on an MR image of a vascular phantom. Only one gross error occurred for all clinical images. All reconstructed surfaces had a realistic, smooth appearance. For all segments of the phantom, vessel radii from the surface reconstruction had an error of less than 0.2 of the average voxel dimension.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A system for modeling an elongated object, said elongated shape being located internal to a body, said system comprising:
a magnetic field generator generating a localized magnetic field;
a radio frequency (RF) energy source generating pulsed RF energy directed towards a body located within said localized magnetic field;
a receiver receiving magnetic energy responsive to pulsed RF energy;
a gradient analyzer analyzing and extracting gradient information from received magnetic resonance energy;
a shape modeler interactively forming a tubular model of an elongated object in said body and impressing said model with extracted gradient information; and
a display displaying said elongated object model.

2. A system as in claim 1, wherein the gradient analyzer comprises:
means for extracting the gradient of received magnetic resonance data;
means for computing the magnitude of said extracted gradient; and
means for extracting the gradient of said gradient magnitude.

3. A system as in claim 1 wherein said shape modeler comprises:
means for interactively defining an axis in said elongated object;
means for defining a reference circumferential direction about said elongated object;
means for defining radial lines extending outward from said axis; and
means for selectively merging radial lines intersecting with one another.

4. A system as in claim 3, wherein axis points are interactively provided to said axis defining means by a user, said system further comprising:
means for interpolating said axis from said provided axis points.

5. A system as in claim 4, wherein said interpolation means connects axis points using a b-spline.

6. A system as in claim 4, wherein the reference circumferential direction is defined as a function of axial position.

7. A system as in claim 4, wherein radial lines are defined extending outwards from said axis for all axial and circumferential positions.

8. A system as in claim 1, wherein said shape modeler comprises:
means for initializing all radial and circumferential positions of an initial model responsive to extracted gradient information, said gradient information representing image and smoothing forces at each radius; and
means for deforming tubular model vertices subject to said image and smoothing forces.

9. A system as in claim 8, wherein said body is a human body.

10. A system as in claim 9, wherein said elongated object is a blood vessel said display displaying a surface model of said blood vessel.

11. A system as in claim 10, wherein said blood vessel is the carotid artery.

12. A system as in claim 10, wherein said blood vessel is the renal artery.

13. A system as in claim 1, wherein said shape modeler comprises:
means for constructing a tubular coordinate system;
means for determining an initial shape of a surface mesh responsive to a gradient magnitude image in said tubular coordinate system; and
means for modifying said initial surface mesh shape responsive to the gradient of said gradient magnitude image within said tubular coordinate system.

14. A method of converting collected image data into a viewable image, said method comprising the steps of:
a) deriving image gradient information from collected image data;
b) defining a tubular model of an elongated object;
c) initializing vertices in said tubular model responsive to said derived gradient information; and
d) deforming vertices of said tubular model responsive to smoothing forces and said derived gradient information.

15. A method as in claim 14, wherein the image data is magnetic resonance image data and the step (a) of deriving said image gradient information comprises the steps of:
i) deriving the gradient of magnetic resonance image data;
ii) deriving the magnitude of said derived gradient; and
iii) deriving the gradient of said derived gradient magnitude.

16. A method as in claim 15, wherein the step (b) of defining said initial tubular model comprises the steps of:
i) defining an object axis;
ii) defining a reference circumferential direction about said object as a function of axial position;
iii) defining radial lines extending outwards from said defined object axis; and
iv) merging intersecting radial lines.

17. A method as in claim 16, wherein the step (iv) of defining said object axis comprises the steps of:
A) interactively defining object axis points; and
B) interpolating between object axis points.

18. A method as in claim 17, wherein said interpolation step (B) comprises using a b-spline to connect defined object axis points.

19. A method as in claim 15, wherein the step (b) of defining said initial tubular model comprises constructing a tubular coordinate system.

20. A method as in claim 19, wherein the step (c) of initializing vertices comprises determining an initial shape of a surface mesh of said tubular coordinate system responsive to a gradient magnitude image.

21. A method as in claim 20, wherein the step (d) of deforming vertex locations comprises modifying said initial surface mesh shape responsive to the gradient of said gradient magnitude image.

22. A method as in claim 14, wherein the tubular object is a blood vessel and the viewable image is a surface of said blood vessel.

23. A method as in claim 22, wherein the blood vessel is a carotid artery, displaying said viewable image indicating carotid artery stenosis.

24. A method as in claim 22, wherein the blood vessel is a renal artery, displaying said viewable image indicating renal artery stenosis.

25. A computer program product for reconstructing a 3D surface of a vessel, said computer program product comprising a computer usable medium having computer readable program code comprising:
computer readable program code means for deriving image gradient information;
computer readable program code means for defining a tubular coordinate system for an elongated object;
computer readable program code means for initializing vertices in said tubular coordinate system responsive to said derived gradient information; and
computer readable program code means for deforming vertex locations in said tubular coordinate system responsive to smoothing forces and said derived image gradient information, said deformed tubular vertices locating a 3D surface of a vessel.

26. A computer program product for reconstructing a vessel surface as in claim 25, wherein the image data is magnetic resonance imaging data and the computer readable program code means for deriving said gradient information comprises:
computer readable program code means for deriving the gradient of magnetic resonance data;
computer readable program code means for deriving the magnitude of said derived gradient; and
computer readable program code means for deriving the gradient of said derived gradient magnitude.

27. A computer program product for reconstructing a vessel surface as in claim 26, wherein the computer readable program means for defining said tubular coordinate system comprises:
computer readable program code means for defining an object axis;
computer readable program code means for defining a reference circumferential direction about said object as a function of axial position;
computer readable program code means for defining radial lines extending outwards from said defined object axis; and
computer readable program code means for merging intersecting radial lines.

28. A computer program product for reconstructing a vessel surface as in claim 27, wherein the computer readable program code means for defining said object axis comprises:
computer readable program code means for interactively defining object axis points; and
computer readable program code means for interpolating between object axis points.

29. A computer program product for reconstructing a vessel surface as in claim 28, wherein interpolation comprises:
computer readable program code means for using a b-spline to connect defined object axis points.

30. A computer program product for reconstructing a vessel surface as in claim 29 further comprising:
computer readable program code means for causing said vessel surface to be displayed.

31. A computer program product for reconstructing a vessel surface as in claim 30, wherein the vessel is a carotid artery, displaying said vessel surface indicating carotid artery stenosis.

32. A computer program product for reconstructing a vessel surface as in claim 30, wherein the vessel is a renal artery, displaying said vessel surface indicating renal artery stenosis.
